(19) United States
(12) Patent Application Publication
(10) Pub. No.: US 2011/0264631 A1
(43) Pub. Date: Oct. 27, 2011

(54) METHOD AND SYSTEM FOR DE-IDENTIFICATION OF DATA

(75) Inventors: Prateek Sharma, Fremont, CA (US); Manmeet Bhasin, Fremont, CA (US)

(73) Assignee: Dataguise Inc., Fremont, CA (US)

(21) Appl. No.: 13/091,597

(22) Filed: Apr. 21, 2011

Related U.S. Application Data
(60) Provisional application No. 61/342,971, filed on Apr. 21, 2010.

(51) Int. Cl. G06F 17/30

(52) U.S. Cl. 707/687; 707/E17.122

(57) ABSTRACT

A method and system for de-identification of data comprising a plurality of data elements. The method involves identifying one or more portions of the data based on a predefined identification condition. The predefined identification condition is expressed in terms of, but is not limited to, one or more characteristics of the data. Further, one or more de-identification data elements are generated corresponding to the one or more data elements of the one or more identified portions of the data. The one or more de-identification data elements are generated based on the one or more characteristics of the one or more portions of the data. Thereafter, the one or more portions of the data are replaced with the one or more de-identification data elements respectively. As a result, the format of the one or more de-identification data elements remains identical to the format of the one or more data elements.

### RELATED APPLICATIONS

This patent application claims the benefit of priority to U.S. Provisional Patent Application No. 61/342,971 filed Apr. 21, 2010, and incorporated herein by reference.

### FIELD OF THE INVENTION

The invention generally relates to de-identification of data. More specifically, the invention relates to a method and system for de-identifying data while preserving the format of the data.

### BACKGROUND OF THE INVENTION

Due to various legal obligations, organizations need to comply with regulations which require de-identification of production data used in non-production environments such as development, Quality Assurance (QA), testing, research etc. Further, the regulations may vary from country to country but most countries have similar regulations in one form or another, for example, Gramm-Leach-Bliley Act (GLBA), Health Insurance Portability and Accountability Act (HIPAA) and Payment Card Industry Data Security Standard (PCIDSS) etc. Such regulations lead to the need for securing sensitive data by de-identifying the sensitive data for organizations. Further, the de-identified sensitive data may need to be valid for reliable use in non-production environments.

There is, therefore, a need for a method and system for de-identifying data while preserving the format of the data.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a flowchart of a method of de-identification of data in accordance with an embodiment of the invention.

FIG. 2 illustrates a flowchart of a method of de-identification of data in accordance with another embodiment of the invention.

FIG. 3 illustrates a system for de-identification of data in accordance with an embodiment of the invention.

FIG. 4 illustrates a system for de-identification of data in accordance with another embodiment of the invention.

FIG. 5 illustrates an apparatus for de-identification of data in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to method and system for de-identification of data. Accordingly, the system components, apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods and systems for de-identification of data comprising a plurality of data elements. De-identification of data is a method of obscuring or masking sensitive portions of data in a data store. The method of de-identification of data ensures that the sensitive portions of the data are replaced with realistic but not real data. Further, the de-identification of the data avoids exposing the sensitive portions of the data to unauthorized access to sensitive data. The de-identification of the data maintains usability of the data in activities, like development, Quality Assurance (QA), testing, research etc.

The method involves identifying one or more portions of the data based on a predefined identification condition. A portion of the data may include one or more data elements. The predefined identification condition is expressed in terms of, but is not limited to, one or more characteristics of the data. The one or more characteristics of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. Additionally, the predefined identification condition may include context parameters corresponding to the data such as, but not limited to, location, time, role, and priority.

Further, one or more de-identification data elements are generated corresponding to the one or more data elements of the one or more identified portions of the data. The one or more de-identification data elements are generated based on the one or more characteristics of the one or more portions of the data. Thereafter, the one or more portions of the data are replaced with the one or more de-identification data elements respectively to perform de-identification of the data. As a result, the format of the one or more de-identification data elements remains identical to the format of the one or more data elements.

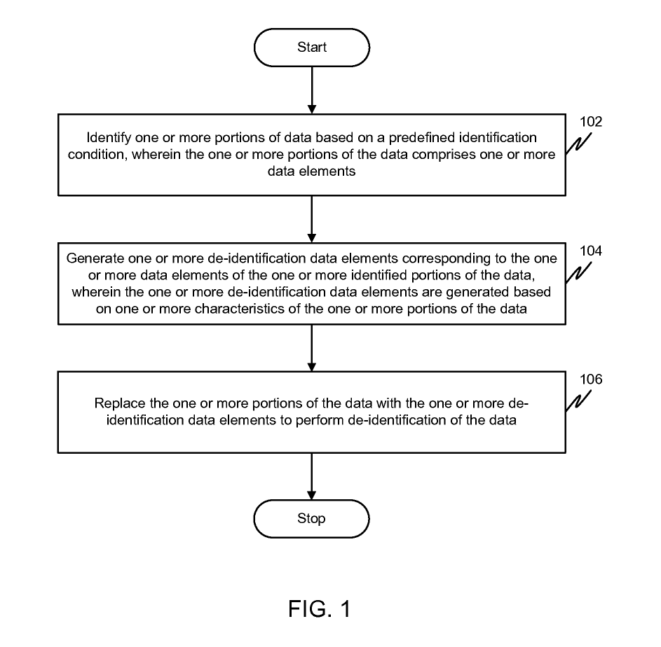

FIG. 1 illustrates a flowchart of a method of de-identification of data in accordance with an embodiment of the invention. The data comprises a plurality of data elements. As shown in FIG. 1, at step 102, one or more portions of the data are identified based on a predefined identification condition. A portion of the data may include one or more data elements. The predefined identification condition is expressed in terms of, but is not limited to, one or more characteristics of the data. The one or more characteristics of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. In addition, the predefined identification condition may include context parameters corresponding to the data such as, but not limited to, location, time, role, and priority.

The class of the one or more data elements includes, but is not limited to, one or more of an alphabet, a numeral and a special character. For example, a class of a data element ‘D’ is alphabet, represented by a symbol ‘A’. Similarly, a class of a data element ‘7’ is numeral, represented by a symbol ‘N’. Likewise, a class of a data element ‘*’ is special character, represented by a symbol ‘S’.

The value of the one or more data elements is an instance of the class corresponding to the one or more data elements. For example, a value of a data element ‘6’ is an instance of a class ‘N’ representing a quantity six. Similarly, a value of a data element ‘D’ is an instance of a class ‘A’ representing an alphabet ‘D’. Likewise, a value of a data element ‘*’ is an instance of a class S representing an asterisk symbol. Further, the value of the one or more data elements may be a code corresponding to the one or more data elements. The code may be one or more of, but not limited to, a Universal Character Set (UCS) code, a UCS Transformation Format-8 bit (UTF-8) code, a UCS Transformation Format-16 bit (UTF-16) code, a UCS Transformation Format-32 bit (UTF-32) code, and an American Standard Code for Information Interchange (ASCII) code. For example, a value of a data element ‘G’ may be ASCII code 71 in a decimal format.

The case of the one or more data elements includes, but not limited to, an uppercase and a lowercase. For example, a case of a data element ‘C’ is uppercase. Similarly, a case of a data element ‘c’ is lowercase.

Further, the position of the one or more data elements within the data is an index value corresponding to the one or more data elements within the data. For example, in the data shown below, a position of a data element ‘Z’ is 2.

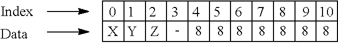

The length of one or more portions of the data indicates the total number of data elements present in the one or more portions. For example, the length of the portion ‘XYZ’ in the data ‘XYZ-8888888’ is 3. Moreover, the visual representation of the one or more data elements includes, but is not limited to, a font, a size and a color corresponding to the one or more data elements.

Now referring back to identification of the one or more portions of the data based on the predefined identification condition. The predefined identification condition may be for example, exclude the class of numerals and special characters in a data while de-identifying the data. Consider an example of data as ‘XYZ-8888888’. A predefined identification condition can be expressed as: “exclude the class of numerals and special characters in a data while de-identifying the data”. Based on the predefined identification condition, a portion of data is identified as ‘XYZ’. The predefined identification condition indicated is an example, thus the one or more portions of the data may be identified based on any other predefined identification conditions.

Further, at step 104, one or more de-identification data elements are generated corresponding to the one or more data elements of the one or more identified portions of the data. A de-identification data element of the one or more de-identification data elements is one of an alphabet, a numeral, and a special character. The special character may be, but is not limited to, ‘-’, ‘*’, ‘&’, ‘#’, ‘@’, and ‘!’. The one or more de-identification data elements are generated based on the one or more characteristics of the one or more portions of the data. In an embodiment, the one or more de-identification data elements may be generated randomly. For example, de-identification data elements such as ‘H’, ‘B’, and ‘R’ are randomly generated corresponding to characteristics of the identified data elements ‘X’, ‘Y’, and ‘Z’. In another embodiment, a single de-identification data element may be randomly generated corresponding to the characteristics of the one or more data elements. For example, a single de-identification data element ‘K’ is randomly generated corresponding to characteristics of data elements ‘X’, ‘Y’, and ‘Z’. Alternatively, the one or more de-identification data elements may be generated by a random look-up operation performed on a dictionary comprising predefined de-identification data elements.

Thereafter, the one or more portions of the data are replaced with the one or more de-identification data elements at step 106 to perform de-identification of the data. In an embodiment, the one or more portions of the data may be replaced with the one or more de-identification data elements generated randomly. Referring to the previous example, each of the data elements ‘X’, ‘Y’, and ‘Z’ in ‘XYZ-8888888’ is replaced with the randomly generated de-identification data elements ‘H’, ‘B’, and ‘R’, thereby resulting in ‘HBR-8888888’. Alternatively, the one or more portions of the data may be replaced with the single de-identification data element generated randomly. For example, each of the data elements ‘X’, ‘Y’, and ‘Z’ in ‘XYZ-8888888’ is replaced with a randomly generated single de-identification data element ‘K’, resulting in ‘KKK-8888888’.

One or more characteristics of the one or more de-identification data elements are identical to the one or more characteristics of the one or more portions of the data. The one or more characteristics of the one or more de-identification data elements include, but are not limited to, one or more of a class of each de-identification data element, a value of each de-identification data element, a case of each de-identification data element, a position of each de-identification data element, a length of the one or more de-identification data elements, a language of each de-identification data element, and a visual representation of each de-identification data element. For example, class characteristics of de-identification data elements ‘H’, ‘B’, and ‘R’ and class characteristics of the identified data elements ‘X’, ‘Y’, and ‘Z’ are identical. As the characteristics are identical, the format of the one or more de-identification data elements remains identical to the format of the one or more portions of the data. In a scenario, the one or more data elements other than the one or more sensitive data elements may be replaced with random data elements.

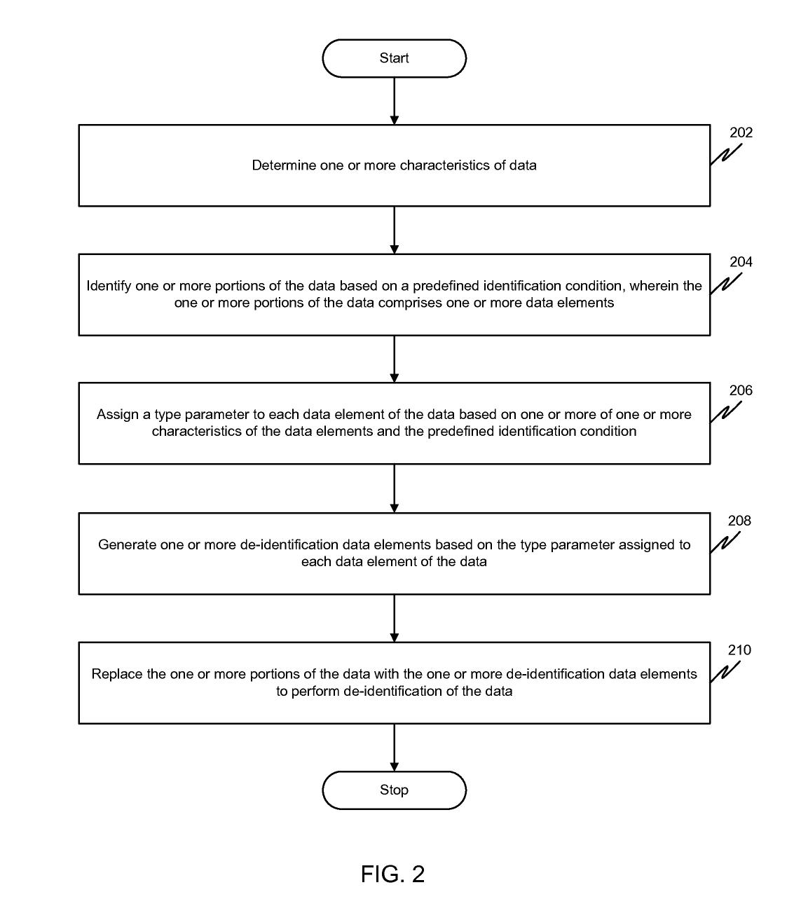

FIG. 2 illustrates a flowchart of a method of de-identification of data in accordance with another embodiment of the invention. The data comprises a plurality of data elements. As shown in FIG. 2, at step 202, one or more characteristics of the data are determined. Upon determining the one or more characteristics of the data, at step 204, one or more portions of the data are identified based on a predefined identification condition. The predefined identification condition is explained in detail in conjunction with FIG. 1. A portion of the data may include one or more data elements. The one or more characteristics of the one or more portions of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. The one or more characteristics of the one or more portions of the data are explained in detail in conjunction with FIG. 1.

Consider an example of data as ‘XYZ-8888888’. In this case, a predefined identification condition can be expressed as: “exclude the class of numerals and special characters in a data while de-identifying the data”. Based on the predefined identification condition, a portion of data is identified as ‘XYZ’. Here, the portion of data ‘XYZ’ is identified from data ‘XYZ-8888888’ for performing de-identification.

Upon identifying the one or more portions of the data, a type parameter is assigned to each data element of the data at step 206. The type parameter is assigned based on, but is not limited to, one or more of the one or more characteristics of the data elements and the predefined identification condition. For example, type parameters may be assigned to the data elements in ‘XYZ-8888888’ based on the characteristics of the data elements and the predefined identification condition. The predefined identification condition may be to exclude numerals and special characters from de-identification. Thus the type parameters are assigned as indicated in the below table:

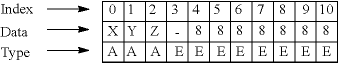

Thereafter, at step 208, one or more de-identification data elements are generated corresponding to the one or more data elements of the one or more identified portions of the data. The one or more de-identification data elements are generated based on the type parameter assigned to the one or more data elements of the data. A de-identification data element of the one or more de-identification data elements is one of an alphabet, a numeral, and a special character. The special character may be, but is not limited to, ‘-’, ‘*’, ‘&’, ‘#’, ‘@’, and ‘!’. In an embodiment, the one or more de-identification data elements may be generated randomly corresponding to the one or more data elements, while ensuring that the type of the one or more de-identification data elements is the same as the type of the one or more corresponding data elements. For example, de-identification data elements such as ‘H’, ‘B’, and ‘R’ are randomly generated corresponding to the type of the identified data elements ‘X’, ‘Y’, and ‘Z’. In another embodiment, a single de-identification data element may be randomly generated corresponding to the type of the one or more data elements. For example, a single de-identification data element ‘K’ is randomly generated corresponding to type of data elements ‘X’, ‘Y’, and ‘Z’. The generation of the one or more de-identification data elements based on the type parameter assigned to the one or more data elements avoids exposing the one or more sensitive data elements to a software program which generates the one or more de-identification data elements.

Thereafter, the one or more portions of the data are replaced with the one or more de-identification data elements at step 210 to perform de-identification of the data. In an embodiment, the one or more portions of the data may be replaced with the one or more de-identification data elements generated randomly. Referring to the previous example, each of the data elements ‘X’, ‘Y’, and ‘Z’ in ‘XYZ-8888888’ is replaced with the randomly generated de-identification data elements ‘H’, ‘B’, and ‘R’, thereby resulting in ‘HBR-8888888’. Alternatively, the one or more portions of the data may be replaced with the single de-identification data element generated randomly. For example, each of the data elements ‘X’, ‘Y’, and ‘Z’ in ‘XYZ-8888888’ is replaced with a randomly generated single de-identification data element ‘K’, resulting in ‘KKK-8888888’.

One or more characteristics of the one or more de-identification data elements may be identical to the one or more characteristics of the one or more portions of the data. The one or more characteristics of the one or more de-identification data elements are explained in detail in conjunction with FIG. 1. For example, class characteristics of de-identification data elements ‘H’, ‘B’, and ‘R’ and class characteristics of the identified data elements ‘X’, ‘Y’, and ‘Z’ are identical. As the class characteristics are identical, the format of the one or more de-identification data elements remains identical to the format of the one or more portions of the data.

The method for de-identification of data comprising a plurality of data elements is further illustrated using the following example. Consider a database table as shown in Table 1.

TABLE 1

| | Column 1 |
|---|---|
| Row 1 | 601-23-3224 |
| Row 2 | PS564354984 |
| Row 3 | RS*G7429984 |
| Row 4 | SGS3* |

In this example,
601-23-3224 represents data stored in Column 1 and Row 1,
PS564354984 represents data stored in Column 1 and Row 2,
RS*G7429984 represents data stored in Column 1 and Row 3, and
SGS3* represents data stored in Column 1 and Row 4.

To de-identify the data, initially one or more characteristics of the data are determined. In a scenario, a characteristic may be a class of the one or more data elements. The class of the one or more data elements includes, but is not limited to, an alphabet (represented by symbol A), a numeral (represented by symbol N) and a special character (represented by symbol S). For example, the class of the data elements in the data ‘RS*G7429984’ of Table 1 is indicated as shown below:

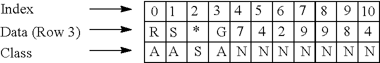

In another scenario, the characteristic of the data may be a value of the one or more data elements. For example, the value of the data elements in the data ‘PS564354984’ of Table 1 is identified as shown below:

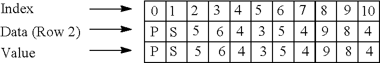

In yet another scenario, the characteristic of the data may be a position of the one or more data elements within the data. For example, the position of the data elements in the data PS564354984′ of Table 1 represented by an index is determined as shown below:

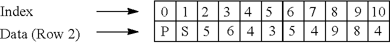

Further, in another scenario, the characteristic of the data may be a length of one or more portions of the data. For example, the length of the portion ‘3224’ in the data ‘601-23-3224’ of Table 1 is identified as 4. Similarly, the length of the portions ‘601-23-3224’ in the data ‘601-23-3224’ of Table 1 is identified as 11. Further, the characteristic of the data may include a language of the one or more data elements. For example, the language of each of the data elements in the data PS564354984′ of Table 1 is identified as the English language.

Once the one or more characteristics of the data are determined, one or more portions of the data are identified based on a predefined identification condition. For example, a predefined identification condition may be expressed as: “exclude class numeral with value ‘6’ and ‘3’ of the data stored in Row 1 and Row 2 of Table 1 from de-identification”. The predefined identification condition expressed for excluding numerals ‘6’ and ‘3’ is represented as ‘E {6, 3}’. Subsequently, in an embodiment, a type is assigned to the data elements of the data stored in Row 1 and Row 2 of Table 1. The type is assigned to each of the data elements based on the one or more characteristics of the data elements and the predefined identification condition as shown below:

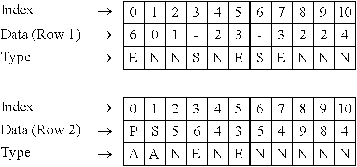

Similarly, the predefined identification condition may be expressed to include one or more data elements in the data of Table 1 for de-identification based on the one or more characteristics of the one or more data elements. For example, the predefined identification condition may be expressed as: “include class numeral with value ‘6’ and ‘3’ for de-identification of the data stored in Table 1”. In this scenario, the type parameter “I” may be used to satisfy the predefined identification condition.

In another example, the predefined identification condition may be expressed as: “exclude the data elements from a position with index value 2 to a position with index value 6 from de-identification of the data stored in Row 1, Row 2, and Row 3 of Table 1. Subsequently, in an embodiment, a type parameter is assigned to the data elements of the data stored in Row 1, Row 2, and Row 3 of Table 1. The type parameter is assigned to each data element based on the one or more characteristics of the data elements and the predefined identification condition as shown below:

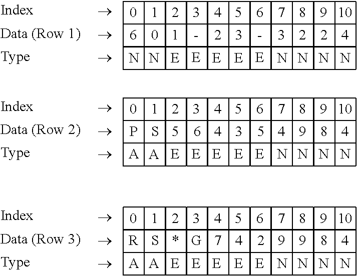

Similarly, the predefined identification condition may be expressed as: “include the data elements from a position with index value 2 to a position with index value 6 for de-identification of the data stored in Table 1”.

As yet another example, the predefined identification condition may be expressed as: “include a data portion of length less than 11 for de-identification of the data stored in Table 1”. The predefined identification condition may be represented as L {<11}. In such a case, a data portion of Row 4 is identified having a length of 4 which is less than 11. Subsequently, a type is assigned to each of the data elements of the data in Row 4. The type is assigned to each of the data elements based on the one or more characteristics of the data elements and the predefined identification condition as shown below:

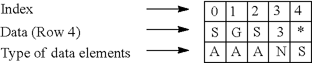

Similarly, the predefined identification condition may be expressed as: “exclude a data portion of length less than 11 from de-identification of the data stored in Table 1”.

Subsequent to assigning a type to the one or more data elements of the data in Table 1, the one or more identified data elements are replaced with one or more de-identification data elements respectively. For example, consider the predefined identification condition expressed as: “exclude class numeral with value ‘6’ and ‘3’ of the data stored in Row 1 and Row 2 of Table 1 from de-identification”. The one or more de-identification data elements are generated randomly while ensuring that the type of the one or more de-identification data elements remains the same as the corresponding type of the one or more sensitive data elements as shown below:

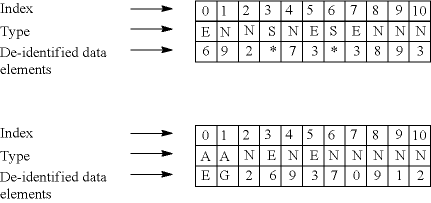

The generation of the one or more de-identification data elements based on the type of the one or more data elements avoids exposing the one or more sensitive data elements to a software program which generates the one or more de-identification data elements. In addition, a physical size of a column of a database table is preserved after de-identification irrespective of the format of the data stored in the column.

Alternatively, in an embodiment, the one or more de-identification data elements may be generated directly based on the one or more characteristics of the one or more data elements of the data without assigning a type to the one or more data elements. For example, consider a predefined identification condition expressed as: “exclude class numeral with value ‘6’ and ‘3’ of the data stored in Row 1 and Row 2 of Table 1 from de-identification”. The one or more de-identification data elements may be generated randomly corresponding to the one or more sensitive data elements identified based on the predefined identification condition, while ensuring that the type of the one or more de-identification data elements remains the same as the corresponding type of the one or more sensitive data elements as shown below:

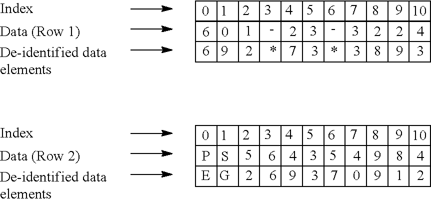

As another example, consider a predefined identification condition expressed as: “exclude the special character ‘-’ from de-identification of Row 1 in Table 1”. Accordingly, the one or more de-identification data elements may be generated randomly corresponding to the one or more sensitive data elements identified based on the predefined identification condition, while ensuring that the type of the one or more de-identification data elements remains the same as the corresponding type of the one or more sensitive data elements as shown below:

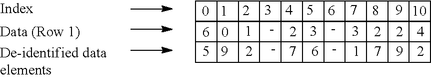

In an embodiment, the one or more data elements other than the one or more sensitive data elements may be replaced with random data elements. For example, consider a predefined identification condition expressed as: “include data elements ‘1’, ‘-’, and ‘2’ of the data stored in Row 1 of Table 1 for de-identification”. Subsequently, in an embodiment, a type is assigned to the data elements of the data stored in Row 1 of Table 1. The type is assigned to each of the data elements based on the one or more characteristics of the data elements and the predefined identification condition as shown below:

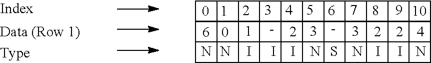

Thereafter, data elements ‘1’, ‘-’, and ‘2’ are replaced with one or more de-identification data elements, while ensuring that the type of one or more de-identification data elements is the same as the type of the data elements ‘1’, ‘-’, and ‘2’ respectively. Further, the one or more data elements other than the one or more sensitive data elements may be replaced with random data elements as shown below:

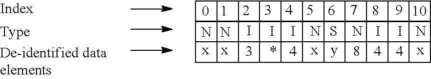

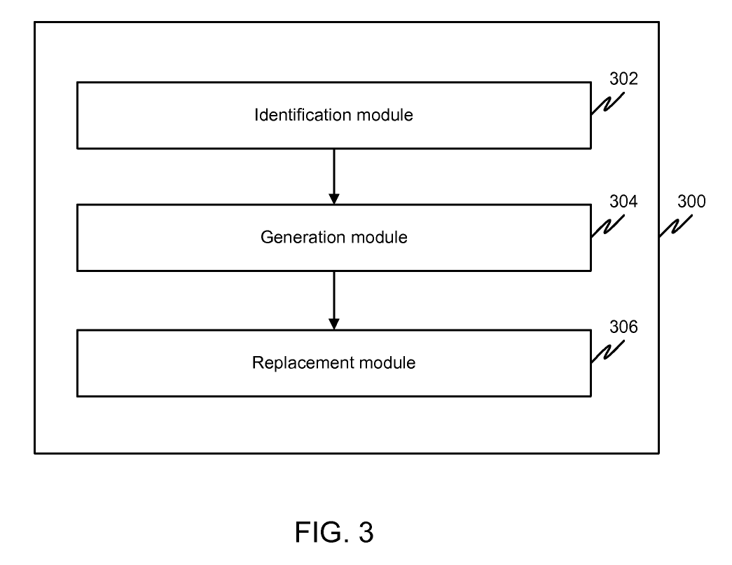

Now referring to FIG. 3 illustrating a system 300 for de-identification of data in accordance with an embodiment of the invention. The data comprises a plurality of data elements. As shown in FIG. 3, system 300 includes an identification module 302 for identifying one or more portions of the data based on a predefined identification condition. A portion of the data may include one or more data elements. The predefined identification condition is expressed in terms of, but is not limited to, one or more characteristics of the data. The one or more characteristics of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. For example, a predefined identification condition can be expressed as: “exclude the class of alphabets in a data while de-identifying the data”. In addition, the predefined identification condition may include context parameters corresponding to the data such as, but not limited to, location, time, role, and priority. This is explained in detail in conjunction with FIG. 1 and FIG. 2.

Upon identifying the one or more portions of the data, a generation module 304 generates one or more de-identification data elements corresponding to the one or more data elements of the one or more identified portions of the data. A de-identification data element of the one or more de-identification data elements is one of an alphabet, a numeral, and a special character. The special character may be, but is not limited to, ‘-’, ‘*’, ‘&’, ‘#’, ‘@’, and ‘!’. The one or more de-identification data elements are generated based on the one or more characteristics of the one or more identified portions of the data which is explained in conjunction with FIG. 1.

Upon generating the one or more de-identification data elements, a replacement module 306 replaces the one or more portions of the data with the one or more de-identification data elements to perform de-identification of the data. One or more characteristics of the one or more de-identification data elements are identical to the one or more characteristics of the one or more portions of the data. The one or more characteristics of the one or more de-identification data elements may include, but are not limited to, one or more of a class of each de-identification data element, a value of each de-identification data element, a case of each de-identification data element, a position of each de-identification data element, a length of the one or more de-identification data elements, a language of each de-identification data element, and a visual representation of each de-identification data element. As the one or more characteristics of the one or more de-identification data elements and the one or more characteristics of the data elements in the one or more portions of the data are identical, the format of the one or more de-identification data elements remains identical to the format of the one or more portions of the data. In a scenario, replacement module 306 may replace the one or more data elements of the data other than the one or more identified portions of the data with random data elements.

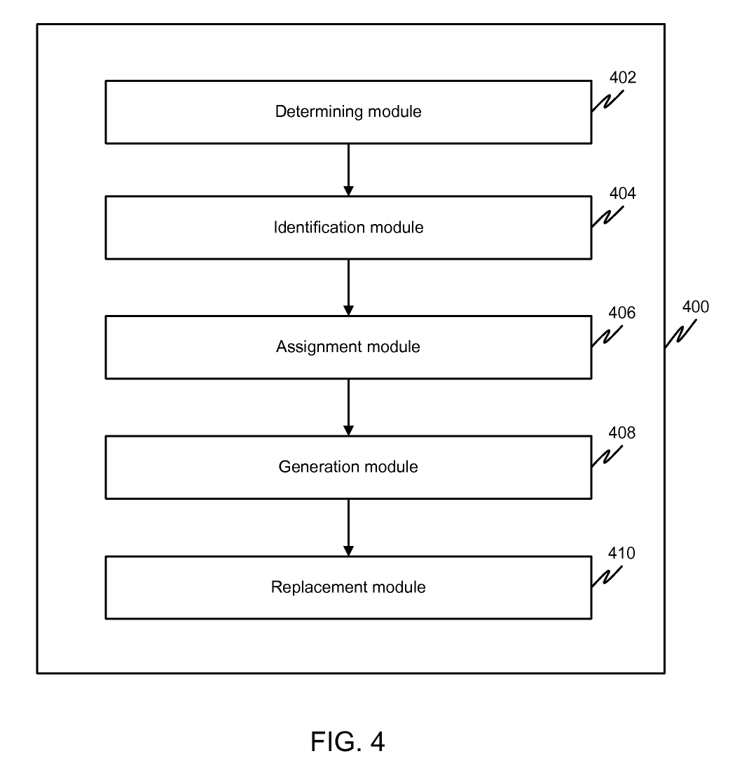

FIG. 4 illustrates a system 400 for de-identification of data in accordance with another embodiment of the invention. The data comprises a plurality of data elements. System 400 includes a determining module 402 for determining the one or more characteristics of the data. Upon determining the one or more characteristics of the data, an identification module 404 identifies one or more portions of the data based on a predefined identification condition. A portion of the data may include one or more data elements. The predefined identification condition and the one or more characteristics of the data are explained in detail in conjunction with FIG. 1. The one or more characteristics of the one or more portions of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements.

Upon identifying the one or more portions of the data, an assignment module 406 assigns a type parameter to each data element of the data. The type parameter is assigned based on, but is not limited to, one or more of the one or more characteristics of the data elements and the predefined identification condition. The method of assigning the type parameter to each data element is explained in detail in conjunction FIG. 1 and FIG. 2.

Further, a generation module 408 generates one or more de-identification data elements corresponding to the one or more data elements based on the type of the one or more data elements of the data. A de-identification data element of the one or more de-identification data elements is one of an alphabet, a numeral, and a special character. The special character may be, but is not limited to, ‘-’, ‘*’, ‘&’, ‘#’, ‘@’, and ‘!’. The generation of the one or more de-identification data elements based on the type of the one or more data elements avoids exposing the one or more sensitive data elements to a software program which generates the one or more de-identification data elements.

In an embodiment, generation module 408 may randomly generate the one or more de-identification data elements. In another embodiment, generation module 408 may generate the one or more de-identification data elements by a random look-up operation performed on a dictionary comprising predefined de-identification data elements.

Thereafter, a replacement module 410 replaces the one or more portions of the data with the one or more de-identification data elements to perform de-identification of the data. One or more characteristics of the one or more de-identification data elements are identical to the one or more characteristics of the one or more portions of the data. The one or more characteristics of the one or more de-identification data elements are further explained in detail in conjunction with FIG. 3. The format of the one or more de-identification data elements remains identical to the format of the one or more portions of the data. In a scenario, replacement module 410 may replace one or more data elements of the data other than the one or more identified portions of the data with random data elements.

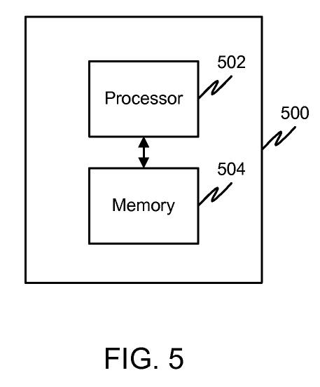

FIG. 5 illustrates an apparatus 500 for de-identification of data in accordance with an embodiment of the invention. The data comprises a plurality of data elements. As shown in FIG. 5, apparatus 500 includes a processor 502 and a memory 504 coupled to processor 502. Processor 502 identifies one or more portions of the data based on a predefined identification condition. A portion of the data may include one or more data elements. The predefined identification condition is expressed in terms of, but is not limited to, one or more characteristics of the data. The one or more characteristics of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. For example, a predefined identification condition can be expressed as: “exclude the class of alphabets in a data while de-identifying the data”. In addition, the predefined identification condition may include context parameters corresponding to the data such as, but not limited to, location, time, role, and priority.

In an embodiment, processor 502 identifies one or more portions of the data based on a predefined identification condition subsequent to determining one or more characteristics of the data. The one or more characteristics of the one or more portions of the data include, but are not limited to, one or more of a class of one or more data elements, a value of one or more data elements, a case of one or more data elements, a position of one or more data elements within the data, a length of one or more portions of the data, a language of one or more data elements, and a visual representation of one or more data elements. The one or more portions of the data identified by processor 502 are saved in memory 504.

Upon identifying one or more portions of the data, in an embodiment, processor 502 may generate one or more de-identification data elements corresponding to the one or more data elements of the one or more identified portions of the data. The one or more de-identification data elements are generated based on the one or more characteristics of the one or more portions of the data. A de-identification data element of the one or more de-identification data elements is one of an alphabet, a numeral, and a special character. The special character may be, but is not limited to, ‘-’, ‘*’, ‘&’, ‘#’, ‘@’, and ‘!’. In a scenario, processor 502 assigns a type parameter to each data element of the data. The type parameter is assigned based on, but is not limited to, one or more of the one or more characteristics of the data elements and the predefined identification condition. In another embodiment, processor 502 may generate one or more de-identification data elements corresponding to the one or more data elements based on the type of the one or more data elements of the data. The one or more de-identification data elements generated by processor 502 are saved in memory 504. The generation of the one or more de-identification data elements based on the type of the one or more data elements avoids exposing the one or more sensitive data elements to a software program which generates the one or more de-identification data elements.

In an embodiment, processor 502 may randomly generate the one or more de-identification data elements. In another embodiment, processor 502 may generate the one or more de-identification data elements by a random look-up operation performed on a dictionary comprising predefined de-identification data elements.

Thereafter, processor 502 replaces the one or more portions of the data with the one or more de-identification data elements to perform de-identification of the data. One or more characteristics of the one or more de-identification data elements are identical to the one or more characteristics of the one or more portions of the data. The one or more characteristics of the one or more de-identification data elements includes, but are not limited to, one or more of a class of each de-identification data element, a value of each de-identification data element, a case of each de-identification data element, a position of each de-identification data element, a length of the one or more de-identification data elements, a language of each de-identification data element, and a visual representation of each de-identification data element. As the one or more characteristics of the one or more de-identification data elements and the one or more characteristics of the data elements in the one or more portions of the data are identical, the format of the one or more de-identification data elements remains identical to the format of the one or more portions of the data. In a scenario, processor 502 may replace one or more data elements of the data other than the one or more identified portions of the data with random data elements. This is explained in detail in conjunction with FIG. 1 and FIG. 2.

Various embodiments of the present invention provide method and systems for de-identification of data while preserving the format of the data. The format of the data is preserved as one or more characteristics of one or more de-identification data elements remains identical to one or more characteristics of the data being de-identified. The format of the data is preserved even after randomly de-identifying one or more data elements of the data. Further, a need for manually creating complex scripts for performing the de-identification of one or more sensitive data elements of the data present in multiple formats is eliminated. In addition, in case of the data being stored in a database tabular form, a physical size of a column of a database table is preserved after de-identification irrespective of the format of the data stored in the column. In addition, the method requires minimum computations for generating a large volume of de-identification data for de-identifying the sensitive data.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. A method of de-identification of data, wherein the data comprises a plurality of data elements, the method comprising:
identifying at least one portion of the data based on a predefined identification condition, wherein the at least one portion of the data comprises at least one data element;
generating at least one de-identification data element corresponding to the at least one data element of the at least one identified portion of the data, wherein the at least one de-identification data element is generated based on at least one characteristic of the at least one portion of the data; and
replacing the at least one portion of the data with the at least one de-identification data element, thereby performing the de-identification of the data.

2. The method of claim 1 further comprising determining at least one characteristic of the data.

3. The method of claim 1, wherein the at least one characteristic of the at least one portion of the data comprises at least one of a class of at least one data element, a value of at least one data element, a case of at least one data element, a position of at least one data element within the data, a length of the at least one portion of the data, a language of at least one data element, and a visual representation of at least one data element.

4. The method of claim 3, wherein the class of the at least one data element comprises at least one of an alphabet, a numeral, and a special character.

5. The method of claim 3, wherein the value of the at least one data element comprises a code corresponding to the at least one data element.

6. The method of claim 3, wherein the code corresponding to the at least one data element comprises at least one of a Universal Character Set (UCS) code, a UCS Transformation Format-8 bit (UTF-8) code, a UCS Transformation Format-16 bit (UTF-16) code, a UCS Transformation Format-32 bit (UTF-32) code, and an American Standard Code for Information Interchange (ASCII) code.

7. The method of claim 3, wherein the case of a data element is one of an upper case and a lower case.

8. The method of claim 3, wherein the length of the at least one portion of the data indicates a number of data elements of the at least one portion of the data.

9. The method of claim 3, wherein the visual representation of the at least one data element comprises at least one of a font, a size, and a color.

10. The method of claim 1, wherein a de-identification data element is one of an alphabet, a numeral and a special character.

11. The method of claim 1, wherein at least one characteristic of the at least one de-identification data element is identical to the at least one characteristic of the at least one portion of the data.

12. The method of claim 11, wherein the at least one characteristic of the at least one de-identification data element comprises at least one of a class of each de-identification data element, a value of each de-identification data element, a case of each de-identification data element, a position of each de-identification data element, a length of the at least one de-identification data element, a language of each de-identification data element, and a visual representation of each de-identification data element.

13. The method of claim 1 further comprising assigning a type parameter to each data element of the data based on at least one of at least one characteristic of the data elements and the predefined identification condition.

14. The method of claim 13, wherein the at least one de-identification data element is generated based on the type parameter assigned to each data element of the data.

15. An apparatus for de-identification of data, wherein the data comprises a plurality of data elements, the apparatus comprises:
a processor configured to:
identify at least one portion of the data based on a predefined identification condition, wherein the at least one portion of the data comprises at least one data element;
generate at least one de-identification data element corresponding to the at least one data element of the at least one identified portion of the data, wherein the at least one de-identification data element is generated based on at least one characteristic of the at least one portion of the data; and
replace the at least one portion of the data with the at least one de-identification data element, thereby performing the de-identification of the data; and
a memory coupled to the processor, wherein the memory is configured to store the at least one portion of the data and the at least one de-identification data element.

16. The apparatus of claim 15, wherein the processor is further configured to determine at least one characteristic of the data.

17. The apparatus of claim 15, wherein the at least one characteristic of the at least one portion of the data comprises at least one of a class of at least one data element, a value of at least one data element, a case of at least one data element, a position of at least one data element within the data, a length of the at least one portion of the data, a language of at least one data element, and a visual representation of at least one data element.

18. The apparatus of claim 15, wherein at least one characteristic of the at least one de-identification data element is identical to the at least one characteristic of the at least one portion of the data, wherein the at least one characteristic of the at least one de-identification data element comprises at least one of a class of each de-identification data element, a value of each de-identification data element, a case of each de-identification data element, a position of each de-identification data element, a length of the at least one de-identification data element, a language of each de-identification data element, and a visual representation of each de-identification data element.

19. The apparatus of claim 15, wherein the processor is further configured to assign a type parameter to each data element of the data, wherein the type parameter is assigned based on at least one of at least one characteristic of the data elements and the predefined identification condition.

20. A system for de-identification of data, wherein the data comprises a plurality of data elements, the system comprises:
an identification module configured to identify at least one portion of the data based on a predefined identification condition, wherein the at least one portion of the data comprises at least one data element;
a generation module configured to generate at least one de-identification data element corresponding to the at least one data element of the at least one identified portion of the data, wherein the at least one de-identification data element is generated based on at least one characteristic of the at least one portion of the data; and
a replacement module configured to replace the at least one portion of the data with the at least one de-identification data element, thereby performing the de-identification of the data.

21. The system of claim 20 further comprises a determining module configured to determine at least one characteristic of the data.

22. The system of claim 20, wherein the at least one characteristic of the at least one portion of the data comprises at least one of a class of at least one data element, a value of at least one data element, a case of at least one data element, a position of at least one data element within the data, a length of the at least one portion of the data, a language of at least one data element, and a visual representation of at least one data element.

23. The system of claim 20, wherein at least one characteristic of the at least one de-identification data element is identical to the at least one characteristic of the at least one portion of the data, wherein the at least one characteristic of the de-identification data element comprises at least one of a class of each de-identification data element, a value of each de-identification data element, a case of each de-identification data element, a position of each de-identification data element, a length of the at least one de-identification data element, a language of each de-identification data element, and a visual representation of each de-identification data element.

24. The system of claim 20 further comprises an assignment module configured to assign a type parameter to each data element of the data, wherein the type parameter is assigned based on at least one of at least one characteristic of the data elements and the predefined identification condition.
